(19) United States
(12) Patent Application Publication
(10) Pub. No.: US 2008/0299425 A1
(43) Pub. Date: Dec. 4, 2008

(54) Flow Arrangement for Fuel Cell Stacks

(75) Inventors: Timo Kivisaari, Helsinki (FI); Erkko Fontell, Espoo (FI)

Correspondence Address: SMITH-HILL AND BEDELL, P.C., 16100 NW CORNELL ROAD, SUITE 220, BEAVERTON, OR, 97006, US

(73) Assignee: WARTSILA FINLAND OY, Vaasa (FI)

(21) Appl. No.: 11/718,221

(22) PCT Filed: Oct. 4, 2005
(86) PCT No.: PCT/FI05/50345

§ 371 Date: Aug. 31, 2007

(30) Foreign Application Priority Data
Oct. 28, 2004 (FI) 20045407

(51) Int. Cl. H01M 8/18; H01M 8/04

(52) U.S. Cl. 429/20; 429/26

(57) ABSTRACT

A flow arrangement for fuel cell stacks connects fuel cell stacks into fuel stack groups having a number of fuel cell stacks connected in parallel by their anode and cathode parts so that the inlet of the anode part of each fuel cell stack group is in connection with an inlet manifold common to these and that the exhaust of the anode part of each group is connected with an exhaust manifold. Further, the inlet of the cathode part of each group is connected with a cathode part manifold and the exhaust of the cathode part of each group is connected with a cathode part exhaust common to these. The fuel cell stacks are connected in series by their cathode side flows. A by-pass channel system provides flow connection between at least one cathode part manifold subsequent to the fuel cell stack group and the first part of the cathode flow channel system, at a position located prior to the heat exchanger in the flow direction of the gas.

The present invention relates to a flow arrangement for fuel cell stacks according to the preamble of claim 1, the arrangement comprising fuel cell stacks formed by a number fuel cell units, in which each fuel cell unit and fuel cell stack comprises an anode part and a cathode part, the flow arrangement comprising an anode flow channel system and a fuel source, the fuel source being in flow connection with the inlet of the anode part of each fuel cell stack via the inlet part of the anode flow channel system and in which the outlet of the anode part is in connection with the outlet part of the anode flow channel system for directing exhaust gas from each anode part of the fuel cell stack, and a cathode flow system comprising an inlet part forming a flow connection for the cathode gas into the inlet of the cathode part of each fuel cell stack and an exhaust part of the cathode flow channel system, the exhaust part being in connection with the exhausts of the cathode parts for directing exhaust gas from the fuel cell stacks, and a first heat exchanger arranged into the first part of the cathode flow channel system for heating the cathode gas.

Fuel cells enable the production of electric energy by oxidising the fuel gas on the anode side and by further combining the electrons by reducing oxygen or other reducible substance on the cathode side subsequent to having passed via an external circuit producing work. In order to achieve this, fuel as well as oxygen or other reducing substance must be supplied to each fuel cell. Usually this is achieved by creating a flow of fuel and air on the anode and cathode side. However, the potential difference of a single fuel cell typically is so small that in practice a fuel cell unit, a so-called stack, is formed of them, by connecting a number of cells electrically in series. Separate units can then be further connected in series for further increasing voltage. Each fuel cell unit, the so-called stack, must be able to be supplied with the substances needed for the reaction, fuel and oxygen (air), and it must also be possible to exhaust the reaction products away from the unit, i.e. gas flow systems for both the cathode and the anode side are needed. Further, it is preferable for energy economy to recover reaction heat, because especially when using solid oxide fuel cells the temperature can be as high as about 1000° C. As far as process technology is concerned, the arrangement of the anode and cathode side gas flows have an especially large effect on the total efficiency.

U.S. Pat. No. 6,344,289 proposes connecting the gas flows in connection with fuel cell stacks so that on the cathode side the stacks are connected in series and in parallel on the anode side. Further, the publication discloses directing air to between each stack connected in series, thereby facilitating maintaining suitable process conditions and also reducing the necessary total amount of air. The connection shown in the publication is not, however, optimal as far as, for example, space usage is concerned when connecting a number of fuel cell stacks to each other, which is necessary when trying to achieve a total power of hundreds of kilowatts.

The flows of gas into a solid oxide fuel cell application in natural gas operation are schematically shown in publication “Conceptual study of a 250 kW planar SOFC system for CHP application”, E. Fontell et al, Journal of Power Sources 131 (2004) 49-56. The publication proposes accomplishing the anode flow so that the fuel is first preheated, subsequent to which it is introduced into a desulphuring apparatus. The already desulphurized fuel is mixed with anode gas exhausted from the fuel cell and this mixture is directed into a prereformer. In the prereformer the higher hydrocarbons of the gas are split into methane, hydrogen and oxides of carbon (CO, CO₂). Subsequent to this the gas is as well heated by means of anode gas exhausted from the fuel cell and the heated gas is directed into the fuel cell. The air flow of the cathode side is accomplished so that the introduced air is heated by means of the cathode side exhaust air. Part of the cooled exhaust air is directed into a catalytic burner, in which the unrecycled anode side gas is oxidised. The publication shows the stacks being connected in parallel on both their anode and cathode sides. The parallel connection will in practice cause problems when connecting a number of stacks together particularly at cathode side, because with parallel connection, for example, the necessary total amount of air increases so as to be very large due to cooling requirements.

The aim of the invention is to produce a flow arrangement for fuel cell stacks by means of which the above-mentioned problems associated with prior art can be solved. An especial aim of the invention is to provide a flow arrangement for solid oxide fuel cell stacks, by means of which the structure will be both flow technically and heat technically efficient and compact in size and in which arrangement the total efficiency of the process is good.

The aims of the invention are achieved as disclosed in the appended claim 1 and as more closely disclosed in other claims.

The flow arrangement for fuel cell stacks according to the invention comprises fuel cell stacks formed by a number of fuel cell units, in which each fuel cell unit and fuel cell stack comprises an anode part and a cathode part, the flow arrangement comprising an anode flow channel system and a fuel source being in flow connection with the inlet of the anode part of each fuel cell stack via the inlet part of the anode flow channel system and in which the exhaust of the anode part is in connection with the exhaust part of the anode flow channel system for directing exhaust gas away from each anode part of the fuel cell stack. The flow arrangement further comprises a cathode flow channel system comprising an inlet part forming a flow connection for the cathode gas into the inlet of each fuel cell stack and an exhaust part of the cathode flow channel system which is in connection with the exhausts of the cathode parts for directing exhaust gas away from the fuel cell stacks and a first heat exchanger being arranged into the first part of the cathode flow channel system for heating the cathode gas.

A characterizing feature of the invention is that fuel cell stacks are connected into fuel cell stack groups, in which a number of fuel cell stacks are connected in parallel by their anode and cathode parts so that the inlet of the anode part of each fuel cell stack group is connected to an anode part inlet manifold common to these and that the outlet of the anode part of each fuel cell stack group is connected to an anode part outlet manifold common to these further so that the inlet of each cathode part of each group is in connection to a cathode part manifold common to these and that the exhaust of the cathode part of each group is in connection to a cathode part manifold common to these and that the cathode side flows of said fuel cell stack groups are connected in series and that the arrangement comprises a by-pass feed channel system via which at least one cathode part manifold subsequent to fuel cell stack group is in flow connection with the first part of the cathode flow channel system, at a place located before the first heat exchanger in the flow direction of the gas.

Preferably the by-pass feed channel system is in flow connection with all fuel cell stack group manifolds located subsequent to the first fuel cell stack group.

Firstly, such an arrangement allows arranging the gas flows of a sufficient amount of fuel cell units into each other so that the directing of gases in and out to the fuel cell units creates suitable reaction conditions for each anode and cathode of the fuel cell unit. Further, this allows a flexible mutual arrangement of the fuel cell stacks. Additionally, combining the by-pass channel with the manifold located subsequent to the cathode part allows maintaining a relatively small gas volume on the cathode side while allowing an efficient cooling of the cathode side of the fuel cell unit.

The cathode side manifold between the fuel cell stack groups connected to in series on their cathode sides forms a mixing volume, in which the flows coming from the previous fuel cell stack group and exiting to the next fuel cell stack group can freely mix with each other, allowing for a uniform gas being directed to the next fuel cell stack group.

In a flow arrangement according to the present invention the anode flow channel system comprises a pre-reformer that needs water vapour for operation, and in order to fulfil this need the exhaust manifold of the anode part of each fuel cell stack group is in flow connection with the second part of the anode flow channel system and further, the second part of the anode flow channel system is in flow connection with the first part of the anode flow channel system prior to the fuel pre-reformer. Thus, the water vapour contained by the exhaust gas coming from the fuel cell unit can be utilised in connection with splitting the higher hydrocarbons of the fuel.

In a flow arrangement according to the invention the fuel cell stacks preferably consist of solid oxide fuel cell units.

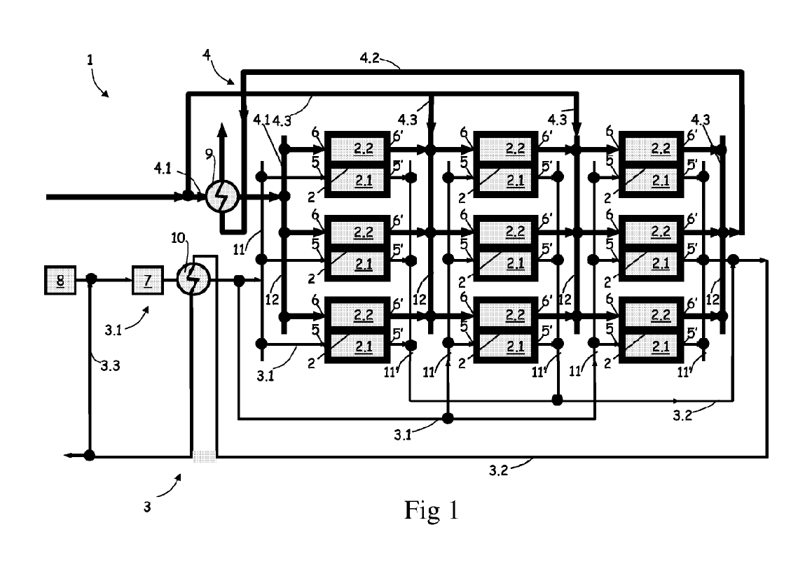

In the following, the invention is explained in an exemplary way, with reference to the appended schematic drawing, in which FIG. 1 is an illustration of a flow arrangement of flow cell stacks according to the invention.

In FIG. 1 the fuel cell flow arrangement 1, in which a number of fuel cell units 2 are connected to each other both by their anode parts 2.1 as well as their cathode parts 2.2. The electrical connection is not shown and it is carried out suitably for each case for creating the desired total voltage.

The flow arrangement comprises the anode flow channel system 3 by means of which the flow of fuel to the anode parts 2.1 and away from them can be carried out and controlled. The anode flow channel system 3 comprises an inlet part 3.1 being formed by the part of the channel system in which the gas flow flows towards the anode parts 2.1 as well as an exhaust part being formed of the parts of channel system in which the gas flow traverses away from the anode parts 2.1. The flow arrangement 1 also comprises a cathode flow channel system 4. It is as well formed by an inlet part 4.1 by means of which cathode gas, usually air, is directed towards the cathode parts 2.2, and an exhaust part 4.2, by means of which gas is directed away from the cathode parts 2.2. In a flow arrangement for fuel cell stacks according to the invention the fuel source 8 is connected to the inlet part 3.1 of the anode flow channel system 3 for feeding fuel to the anode parts 2.1 of the fuel cell stacks 2. Because fuel containing higher hydrocarbons, such as natural gas, is typically used as fuel, a pre-reformer 7 is arranged into the inlet part of the anode flow channel system 3 for splitting the high hydrocarbons into methane, hydrogen and oxides of carbon (CO, CO₂), subsequent to which the composition of the gas is suitable for feeding to solid oxide fuel cells (SOFC). Subsequent to the pre-reformer a heat exchanger 10 (second heat exchanger) is arranged in the inlet part 3.1 of the anode flow channel system 3, by means of which heat exchanger the temperature of the fuel gas can be increased so as to be suitable for an SOFC system. The other side 10 of the heat exchanger is connected to the exhaust part 3.2 of the anode flow channel system 3, whereby the gas to be introduced is heated by cooling the gas flowing in the exhaust part 3.2.

The arrangement also comprises a cathode flow channel system 4 being formed by an inlet part 4.1, by means of which cathode gas can be introduced to the cathode parts 2.2 of the fuel cells and further by an exhaust part 4.2 by means of which cathode gas can be exhausted from the cathode parts 2.2 of the fuel cells. A cathode gas heat exchanger 9 (first heat exchanger) is arranged into the inlet part 4.1 of the cathode flow channel system for increasing the temperature of the cathode gas to be introduced. It is preferably a heat exchanger having one side connected to the exhaust part 4.2 of the cathode flow channel system 4, whereby the gas to be introduced is, in other words, heated by cooling the gas flowing in the exhaust part 4.2.

Fuel cell stacks 2 are connected to form fuel cell stack groups so that a number of fuel cell stacks are connected in parallel both by their anode parts so that the inlet 5 of each anode part 2.1 is in connection with an anode side inlet manifold 11 common to these. Correspondingly, the exhaust 5′ of each anode part 2.1 of the fuel cell stack group is in connection with an anode part exhaust manifold 11′ common to these. Correspondingly, the fuel cell stack group is connected in parallel by their cathode parts 2.2 so that the inlet 6 of cathode part 2.2 of each fuel cell stack group is connected to the cathode part manifold 12 common to these. Correspondingly, the exhaust 6′ of the cathode part 2.2 of each fuel cell stack group is in connection with a cathode part manifold 12 common to these. Because the fuel cell stack groups are connected in series by their cathode parts, the manifold 12 between two fuel cell groups acts simultaneously as an exhaust manifold and an inlet manifold for the next one. The gas is allowed to mix freely in the manifolds between the fuel cell stack groups, whereby the composition of the gas introduced into the next fuel cell stack group is more uniform.

In the arrangement the cathode part manifolds 12 of the fuel cell stack groups subsequent to first the fuel cell stack group are combined via the by-pass feed channel system 4.3 with the first part 4.1 of the cathode flow channel system 4 in a position prior to the first heat exchanger 9 in the flow direction of the gas. This allows the manifolds 12 of the cathode parts of the fuel cell stack groups located subsequent to the first fuel cell stack group to function as a mixing chamber for the gas always coming from the fuel cell stack group and the unheated cathode gas. Thus the temperature of the cathode part of each subsequent fuel cell stack group can be controlled while maintaining the total volume of the cathode gas as low as possible.

Preferably the pre-reformer of the fuel is an adiabatic solid bed steam reformer using water steam in its reaction. It can also be a so-called autothermic steam reformer or a catalytic partial oxidation reactor. Because the exhaust gas of the anode side contains water steam, the exhaust side 3.2 of the anode flow channel system of the flow arrangement is provided with a branch channel 3.3 connecting the exhaust part 3.2 of the anode flow channel system with the inlet part 3.1 of the anode flow channel system in a position before the pre-reformer 7 in the flow direction of the gas. The branch channel 3.3 is connected with the exhaust part 3.2 of the anode flow channel system at a position located subsequent to the second heat exchanger 10 in the flow direction of the gas.

The invention is not limited to the embodiments described here, but a number of modifications thereof can be conceived of within the scope of the appended claims. It is, among others, self-evident that the gas flows can be controlled by arranging valves in suitable places of the flow arrangement.

1-5. (canceled)

6. A flow arrangement for fuel cell stacks comprising fuel cell stacks consisting of a number of fuel cell units, in which each fuel cell unit and fuel cell stack comprises an anode part and a cathode part, the flow arrangement comprising an anode flow channel system and a fuel source being in connection by means of the inlet part of the anode flow channel system with the inlet of the anode part of each fuel cell stack and in which the exhaust of the anode part is in connection with the exhaust part of anode flow channel system for directing exhaust gas away from each anode part of the fuel cell stack, a cathode flow channel system comprising an inlet part forming a flow connection for the cathode gas to the inlet of the cathode part of each fuel cell stack and an exhaust part of the cathode flow channel system being in connection with the exhausts of the cathode parts for directing exhaust gas away from the fuel cell stacks, a first heat exchanger arranged into the first part of the cathode flow channel system, wherein fuel cell stacks are connected into fuel cell stack groups, in which a number of fuel cell stacks are connected in parallel by their anode/and cathode parts so that the inlet of the anode part of each fuel cell stack group is connected to an anode part inlet manifold common to these and that the exhaust of each anode part of each group is in connection with an anode part exhaust manifold common to these, and so that the inlet of each cathode part of each group is in connection to a cathode part manifold common to these and that the exhaust of the cathode part of each group is in connection to a cathode part manifold common to these and that the cathode side flows of said fuel cell stack groups are connected in series and that the arrangement comprises a by-pass feed channel system via which at least one cathode part manifold subsequent to fuel cell stack group is in flow connection with the first part of the cathode flow channel system, in a place located before the first heat exchanger in the flow direction of the gas.

7. A flow arrangement for fuel cell stacks according to claim 6, wherein the anode flow channel system comprises a fuel prereformer and the exhaust manifold of the anode part of each fuel cell stack group is in connection with the second part of the anode flow channel system and the second part of the anode flow channel system is in flow connection with the first part of the anode flow channel system prior to the fuel reformer.

8. A flow arrangement for fuel cell stacks according to claim 6, comprising a by-pass channel system being in flow connection with all manifolds subsequent to the first fuel cell stack group.

9. A flow arrangement for fuel cell stacks according to claim 6, wherein the manifold of the cathode part forms a mixing volume in which the incoming and outgoing flows can freely mix with each other.

10. A flow arrangement for fuel cell stacks according claim 6, wherein the fuel cell stacks are formed of solid oxide fuel cell units.

11. A fuel cell apparatus comprising:
at least first and second groups of fuel cell stacks, each fuel cell stack having an anode part and a cathode part, the anode part and the cathode part of each stack each having an inlet and an exhaust,
an anode flow channel system connected to the inlet of the anode part of each fuel cell stack for supplying fuel to the anode part of each fuel cell stack and also connected to the exhaust of the anode part of each fuel cell stack for removing exhaust gas from the anode part of each fuel cell stack, the anode flow channel system comprising a first anode part inlet manifold connected in common to the inlet of the anode part of each fuel cell stack of the first group, a first anode part outlet manifold connected in common to the exhaust of the anode part of each fuel cell stack of the first group, whereby the anode parts of the fuel cell stacks of the first group are connected in parallel, a second anode part inlet manifold connected in common to the inlet of the anode part of each fuel cell stack of the second group, and a second anode part outlet manifold connected in common to the exhaust of the anode part of each fuel cell stack of the second group, whereby the anode parts of the fuel cell stacks of the second group are connected in parallel,
a cathode flow channel system having an inlet portion connected to the inlet of the cathode part of each fuel cell stack for supplying cathode gas to the cathode part of each fuel cell stack and also having an exhaust portion connected to the exhaust of the cathode part of each fuel cell stack for removing exhaust gas from the cathode part of each fuel cell stack, the cathode flow channel system comprising a first cathode part manifold connected in common to the inlet of the cathode part of each fuel cell stack of the first group, a second cathode part manifold connected in common to the exhaust of the cathode part of each fuel cell of the first group and to inlet of the cathode part of each fuel cell stack of the second group, and a third cathode part manifold connected in common to the exhaust of the cathode part of each fuel cell of the second group, whereby the cathode parts of the fuel cell stacks are connected both in series and in parallel,
a heater for heating gas in the inlet portion of the cathode channel system, and
a by-pass feed channel connecting the inlet portion of the cathode flow channel system to at least one cathode part manifold, said by-pass feed channel being connected to the inlet portion of the cathode flow channel system at a location upstream of the heater relative to flow of cathode gas to the first cathode part manifold and said one cathode part manifold being a cathode part manifold that is connected to the exhaust of the cathode part of each fuel cell stack of a group of fuel cell stacks.

12. A fuel cell apparatus according to claim 11, wherein the heater is a heat exchanger for transfer of heat from the exhaust portion of the cathode channel system to the inlet portion of the cathode channel system.
